(19) United States
(12) Patent Application Publication
(10) Pub. No.: US 2011/0024183 A1
(43) Pub. Date: Feb. 3, 2011

(54) COAXIAL-TYPE CABLE FOR OVERHEAD TRANSMISSION

(75) Inventors: Bernard Clairmont, Cheshire, MA (US); John Chan, Cupertino, CA (US); Rambabu Adapa, Fresno, CA (US); Gary Sibilant, Charlotte, NC (US); Ivo Hug, Mill Valley, CA (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ELECTRIC POWER RESEARCH INSTITUTE, INC., Charlotte, NC (US)

(21) Appl. No.: 12/845,798

(22) Filed: Jul. 29, 2010

Related U.S. Application Data
(60) Provisional application No. 61/230,152, filed on Jul. 31, 2009.

(51) Int. Cl. H02G 7/05

(52) U.S. Cl. 174/40 R

(57) ABSTRACT

This invention relates to an overhead coaxial-type transmission system. The system includes a coaxial-type conductor, a support structure adapted to support the coaxial-type conductor at a pre-determined elevation above the ground, and a conductor support extending downwardly from the horizontal support such that the coaxial-type conductor is secured thereto. The support structure includes a vertical support secured in the ground and a horizontal support secured to and extending outwardly from the vertical support.

### BACKGROUND OF THE INVENTION

This application claims the benefit of Provisional Application No. 61/230,152 filed on Jul. 31, 2009.

Coaxial-type cables have been used in underground AC power transmission and distribution for many years. Transmitting power underground is generally much more expensive than overhead, and therefore is generally used where specific factors do not permit overhead transmission. However, because of capacitance issues, AC power cannot be transmitted long distances with coaxial-type cables, and therefore are also only used when the distance of transmission is relatively short.

On the other hand, DC power transmission does not have the capacitance issue, and may be transmitted very long distances with coaxial-type cables. However, for overhead transmission, DC presents another issue, i.e. electric charge from the conductors is ejected into space, resulting in charged aerosols drifting downwind, ion currents to ground, significant increases in ground level DC electric fields, and increased human perceptions to the electrical environment. Because of these space charge issues, DC transmission is either prohibited, requires larger right-of-ways, or requires expensive mitigation strategies.

Accordingly, there is a need for a cable configuration that allows for overhead DC power transmission.

### BRIEF SUMMARY OF THE INVENTION

These and other shortcomings of the prior art are addressed by the present invention, which provides a coaxial-type cable configuration for overhead DC power transmission.

According to one aspect of the invention, a method of transmitting electricity includes the steps of providing a coaxial-type conductor; running the coaxial-type conductor above ground; and transmitting DC power across the coaxial-type conductor.

According to another aspect of the invention, a coaxial-type transmission system includes a coaxial-type conductor; a support structure adapted to support the coaxial-type conductor at a pre-determined elevation above the ground; and a conductor support extending downwardly from the horizontal support such that the coaxial-type conductor is secured thereto. The support structure includes a vertical support secured in the ground and a horizontal support secured to and extending outwardly from the vertical support.

### BRIEF DESCRIPTION OF THE DRAWINGS

The subject matter that is regarded as the invention may be best understood by reference to the following description taken in conjunction with the accompanying drawing figures in which:

FIG. 1 shows a coaxial-type cable configuration for overhead DC power transmission compared with a conventional bipolar configuration.

### DETAILED DESCRIPTION OF THE INVENTION

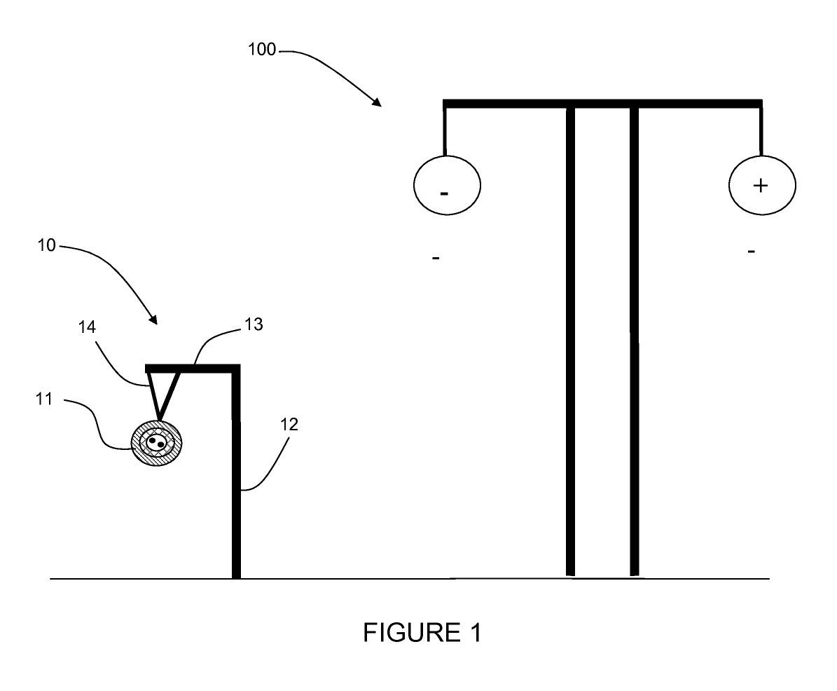

Referring to the drawings, an exemplary coaxial-type configuration for overhead DC power transmission according to an embodiment of the invention is illustrated in FIG. 1 and shown generally at reference numeral 10.

The configuration 10 uses coaxial-type cables 11 (similar to those used for underground AC transmission) for overhead power transmission, particularly for DC power, and includes a vertical support 12, a horizontal support 13 extending outwardly from the vertical support 12, and a conductor support 14 extending downwardly from the horizontal support 13 for securing the cable 11. The configuration 10 helps eliminate the electrical problems associated with the electrical environment produced by field and corona effects (e.g. DC electric fields, space charge, ion currents to ground and other objects under the line, human perceptions). As shown, the smaller structures and right-of-ways compared to conventional bipolar HVDC configurations 100 results in cost savings, and the reduced environmental footprint will help make high voltage DC (HVDC) more acceptable to the public and regulatory bodies. The configuration 10 may also be used for portions of an HVDC (or high voltage AC (HVAC)) transmission line, or used for certain sections of the line.

The configuration 10 uses the cables 11 above ground to reduce the electric field and corona effects at ground level, and for reducing right-of-way and structure size. The burying of underground cable contributes a large percent to the high costs involved with this technology.

Taking into account the facts that DC transmission does not have a distance limitation using coaxial cables, and that DC transmission does have a need to mitigate field effects, coaxial-type cables 11 are used for overhead DC transmission. When used for DC transmission, the distance limitations due to capacitance and the ejection of space charge and all the related issues, including the need for larger corridor widths to accommodate the space charge phenomena, are eliminated. In addition, because a coaxial-type cable requires mush less space than a multi-pole or multi-phase configuration, the structures needed to support a transmission line can be smaller, and the physical space needed to accommodate them will be much less, further reducing the need for corridor width and the associated costs.

Also, the same technique could be used for overhead AC transmission over shorter distances resulting in the same savings regarding structure size and corridor width.

The foregoing has described a coaxial-type cable configuration for overhead DC power transmission. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A method of transmitting electricity, comprising:
(a) providing a coaxial-type conductor;
(b) running the coaxial-type conductor above ground; and
(c) transmitting DC power across the coaxial-type conductor.

2. The method according to claim 1, further including the step of providing a support structure adapted to support the coaxial-type conductor at an elevated position.

3. The method according to claim 2, wherein the support structure includes a single horizontal arm for supporting the coaxial-type conductor.

4. A coaxial-type transmission system, comprising:
(a) a coaxial-type conductor;
(b) a support structure adapted to support the coaxial-type conductor at a pre-determined elevation above the ground, the support structure including a vertical support secured in the ground and a horizontal support secured to and extending outwardly from the vertical support; and
(c) a conductor support extending downwardly from the horizontal support such that the coaxial-type conductor is secured thereto.
